(19) United States
(12) Patent Application Publication
(10) Pub. No.: US 2002/0061778 A1
(43) Pub. Date: May 23, 2002

(54) Method and system for playing computer games sent via electronic mail

(76) Inventor: John Acres, Corvallis, OR (US)

Correspondence Address: PERKINS COIE LLP, PATENT-SEA, P.O. BOX 1247, SEATTLE, WA, 98111-1247, US

(21) Appl. No.: 09/965,647

(22) Filed: Sep. 26, 2001

Related U.S. Application Data
(60) Provisional application No. 60/235,672, filed on Sep. 26, 2000.

(51) Int. Cl. G06F 19/00

(52) U.S. Cl. 463/40; 463/1

(57) ABSTRACT

A method and system for receiving and playing a computer game is provided. In one embodiment, the user executes a game program that is self-contained within an email message sent by a game server computer system. If the outcome of the game indicates success, then the computer game may display instructions on how to redeem a reward. Because the computer game is sent via email, and stored in the user's email system, the user can choose to play the game even when no connection to a game web site is established. The user can later redeem their rewards, if any, when a connection to a redemption web site is established. Thus, the user can play the computer games even when not connected to the game web site.

### CROSS REFERENCE TO RELATED APPLICATION

This application claims the benefit of U.S. Provisional Application No. 60/235,672, entitled “INSTANT GAMES VIA E-MAIL” filed Sep. 26, 2000, which is hereby incorporated by reference.

### TECHNICAL FIELD

The described technology relates generally to computer games, and more particularly, to playing and supplying computer games, and to redeeming rewards won by players of computer games.

### BACKGROUND

Because it facilitates electronic communications between vendors and purchasers, the Internet is increasingly being used to conduct “electronic commerce.” The Internet comprises a vast number of computers and computer networks that are interconnected through communications channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. The World Wide Web portion of the Internet is especially conducive to conducting electronic commerce. Many web servers have been developed through which vendors can advertise and sell products through a web site. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This order information may include the purchaser's name, the purchaser's credit card number, and a shipping address for the order. The server computer system then typically confirms the order by sending a confirming web page to the client computer system and schedules shipment of the items.

The profitability of an e-commerce web site depends in large part on the number of users who visit that web site. To encourage users to visit a web site, the web site may be advertised extensively. It may also offer electronic games that users can play if they visit the site. These games can include everything from simulations of casino-type games such as slot machines and blackjack, to electronic “scratch-off” lottery tickets, modeled after the well-known paper versions sold in state-run lotteries. Such web sites may offer substantial prizes to encourage users to play the games to provide personal information, and buy products. Additionally, while many web sites offer games at no cost, other web sites charge users for opportunities to play and win prizes.

Web sites that offer games spend considerable effort in getting potential players to even visit and to make known the availability of such games. Along with displaying advertisements on the Internet, some sponsors send email messages to individuals, notifying them that such game opportunities are available and providing an embedded link that the email recipient can click on to reach the web site. Many potential participants, however, will not take the trouble to click on the link. This is especially true for the majority of persons that do not have a full-time Internet connection and have to “dial-up” their Internet provider before visiting a site.

It would be desirable to have a new way in which a computer game is played by a computer user, even while the computer is not connected to the Internet.

### BRIEF DESCRIPTION OF THE DRAWINGS

FIG. 1 is a block illustrating the display of a sent and opened email message containing an embedded computer game program and game data in one embodiment.

FIG. 2 illustrates a display of an electronic scratch game before execution in one embodiment.

FIG. 3 is illustrates a display of the electronic scratch game during execution in one embodiment.

FIG. 4 illustrates a display of an electronic scratch game after the game is complete in one embodiment.

FIG. 5 illustrates a display page providing a set of reward redemption options in one embodiment.

FIG. 6 is a flow diagram illustrating the processing of the game program distribution routine in one embodiment.

FIG. 7 is a block diagram illustrating the components of an email package containing an electronic scratch game with a predetermined outcome in one embodiment.

FIG. 8 is a flow diagram illustrating the processing of an electronic scratch game program in one embodiment.

FIG. 9 is a flow diagram illustrating the processing of the reward redemption routine in one embodiment.

FIG. 10 is a block diagram illustrating components used to implement the computer game system in one embodiment.

### DETAILED DESCRIPTION

A method and system for receiving and playing a computer game is provided. In one embodiment, the user executes a game program that is self-contained within an email message sent by a game server computer system. Although the computer game may be of any type, an “instant-win” game is especially suitable for enticing users to play, as this type of game is quick and easy to play, and requires little, if any, skill or instruction. When coupled with a free chance to win, an instant-win game provides a powerful incentive for opening an email that might otherwise be discarded without reading. For example, an electronic version of a “scratch-off” lottery ticket may be used, where the user uses a mouse to remove the covers off of covered game results, revealing the outcome of the game. Other examples of instant-win type games include dice games, slot machine games (where the user electronically pulls a lever causing results to be displayed) and card games such as blackjack or poker. If the outcome of the game indicates success, then the computer game may display instructions on how to redeem a reward. For example, the computer game may provide a link to a redemption web site. Because the computer game is sent via email, and stored in the user's email system, the user can choose to play the game even when no connection to a game web site is established. For example, a user may receive 10 emails containing “scratch-off” lottery tickets, store the emails on their personal digital assistant computer, and then play the games at their leisure. The user can later redeem their rewards, if any, when a connection to a redemption web site is established. Thus, the user can play the computer games even when not connected to the game web site.

Using programming methods such as Java, Java Script, or Flash, the computer game may be animated. Sounds may also be included as part of the game playing experience. For example, when the user selects the covered features on an electronic scratch ticket displayed on a computer, the covering may appear to be slowly scratched away while the user hears a scratching sound. In a slot machine game, the user could send wheels into motion by selecting an electronic lever, and bells may ring if the user wins.

In another embodiment, the user may download a game outcome discovery program from a game web site, rather than having the game program delivered via email. For example, a program that controls the uncovering of a “scratch-off” lottery ticket is such a game outcome discovery program. After downloading the game outcome discovery program, the user receives an email containing game data in a form that may be encoded so the user cannot see the outcome. In order to play the game, the user then executes the game outcome discovery program to process and display the outcome of the separately sent game data. The game outcome discovery program may provide various discovery options so that the user can customize the game playing experience, adding suspense and enjoyment to the outcome discovery process. For example, the user may have the option of using either a scratch game or a slot machine game to discover the outcome of new game data. The user may also have the option to customize the game-playing environment by selecting certain screen colors and animated effects. Alternatively, the email may contain both the game outcome discovery program and the game data. In this way, the user can avoid the extra step of downloading the discovery program from the game web site. In another embodiment, the email may include a program that checks to see if the discovery program has already been downloaded to the user's computer, and if not, automatically downloads it.

The outcome of the computer game may be predetermined, or, alternatively, may depend on the user's actions while playing the computer game, such as the selection of a particular sequence of events or the time spent playing the game. When the user completes playing the game, the game program displays the outcome on the user's computer screen. In the event that the user is successful at the computer game, the user is prompted to redeem a reward from a redemption server. Redemption instructions may also be provided. In one embodiment, a Uniform Resource Locator link to the redemption server may be provided to enable an easy connection to the redemption server. Because the outcome and reward are displayed to the user immediately after playing the game, the chances of using this link to visit the redemption server are increased assuming a connection can easily be established.

Where the outcome of the computer game is determined before the computer game is sent to the user, a verification coding scheme may be used to verify a user's success and to prevent fraud during the redemption process. For example, the email sent to the user containing the game data may contain a secured game outcome code indicating the outcome of the game data sent in that email. The code may be a very large number (e.g., 128 bit) so that the chances of someone generating a valid outcome code would be very small. Where the outcome of the computer game is not predetermined, the game outcome code may be generated and secured by the game program when the user finishes playing the game. In either embodiment, the game outcome code is sent to the redemption server when the user proceeds to redeem the reward. The redemption server may then verify the game outcome code by searching a success code database to ensure that it matches such a code in the database. Encryption may be used along with this verification scheme to prevent fraud. The game outcome code may also be printed in a human-readable form, enabling the user to redeem the reward without the use of a computer network connection, for example, by telephone or mail.

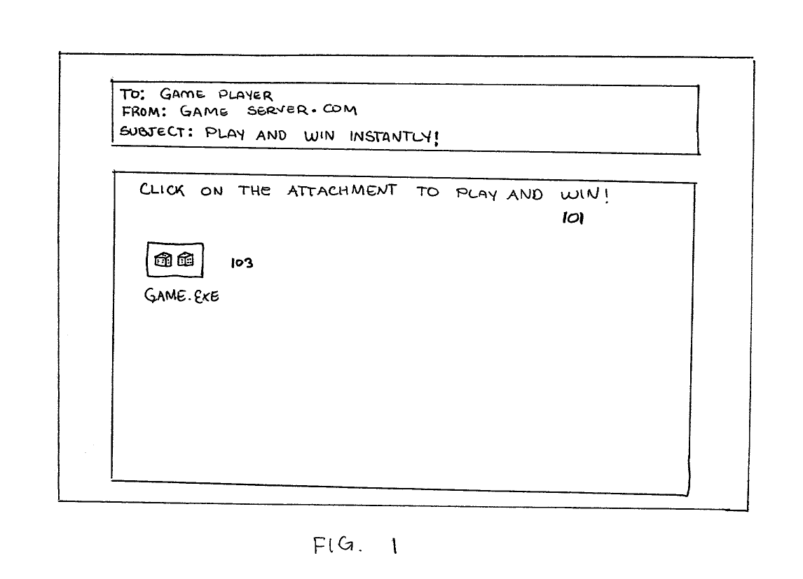

FIG. 1 is a block illustrating the display of a sent and opened email message containing an embedded computer game program and game data in one embodiment. Although the email message is sent and received via a data transmission channel, such as the Internet or a point-to-point dial-up connection, once the message is stored on the user's computer, the game program in this embodiment may be executed without maintaining the data transmission channel. A brief text message 101 directs the user to click on a game file icon 103 to play the computer game. Once the user clicks on this icon, the game program begins executing.

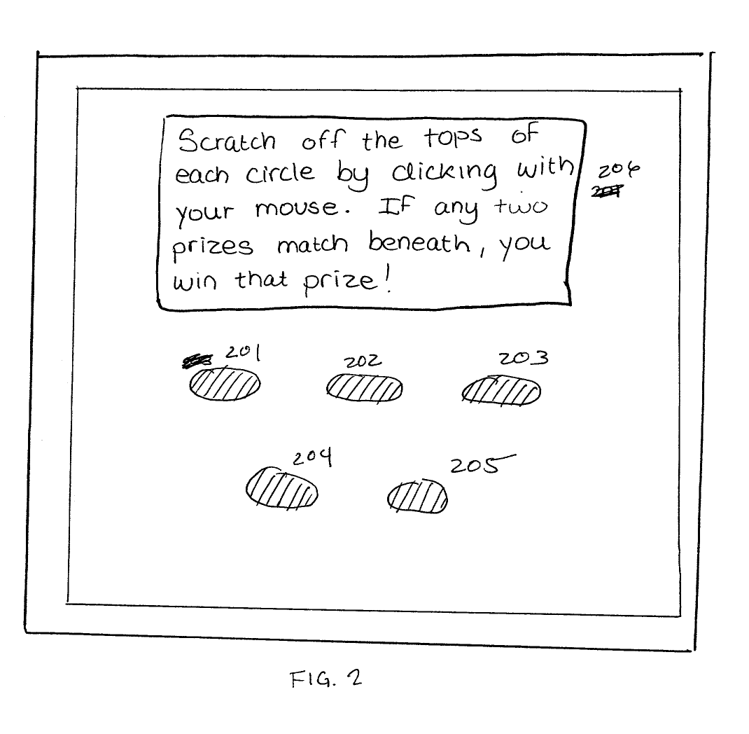

FIG. 2 illustrates a display of an electronic scratch game before execution in one embodiment. The display shows the user's computer screen once execution of the game program has begun, but before the user has commenced play. Instructions 206 for playing the electronic scratch game are provided. The electronic scratch game in this embodiment has five covered ellipses 201-205 that the user is instructed to uncover in order to reveal the results. In this example, the covered ellipses contain dollar amounts (e.g., $10).

If two ellipses contain the same dollar amount, then the user wins. One skilled in the art will appreciate that the ellipses can contain graphics representing any type of item, such as letters, symbols, pictures, and so on.

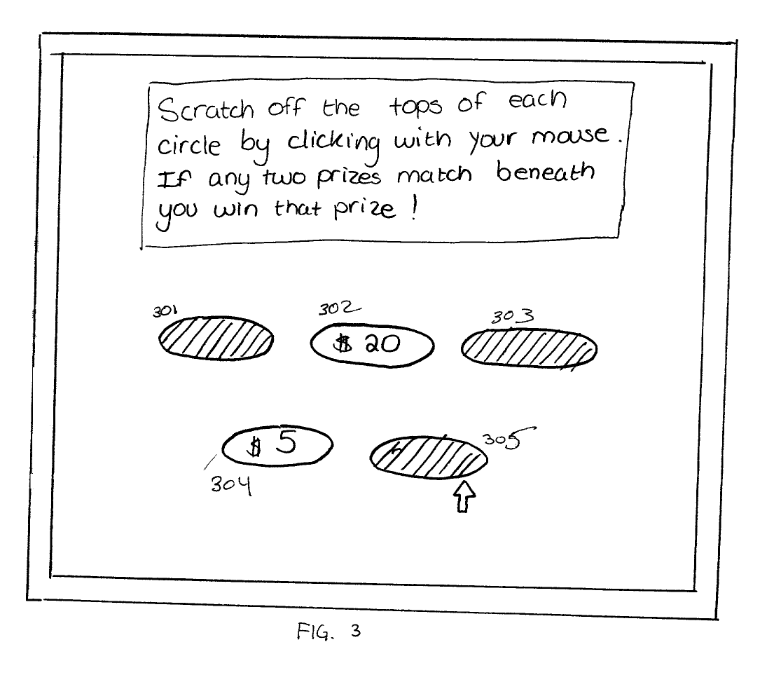

FIG. 3 is illustrates a display of the electronic scratch game during execution in one embodiment. The display shows the user's computer screen once playing of the electronic scratch game has begun. The user has already selected ellipses 302 and 304 using the mouse to uncover $20 and $5 amounts.

The user then selects the covered ellipse 305 using the mouse to uncover a $10 amount. Since none of the dollar amounts yet match, the user continues playing the game. In this particular embodiment, the outcome of the electronic scratch game is predetermined (e.g., by the game server before the email containing the game was sent to the user). Accordingly, the order and manner of the user's selections do not alter the hidden results. Although the outcome of the electronic scratch game is predetermined, the process of uncovering allows the user to enjoy the suspense of discovering the outcome.

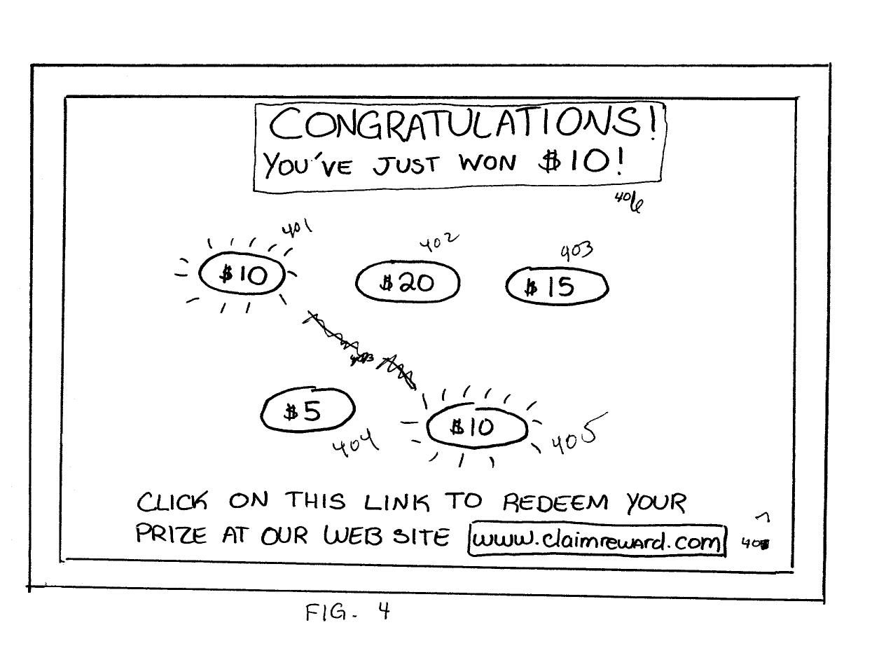

FIG. 4 illustrates a display of an electronic scratch game after the game is complete in one embodiment. The user's computer screen shows that all the ellipses have been uncovered. Here, the user has matched two $10 ellipses 401 and 405 indicating success. A text message 406 indicating that the user has been successful and describing the reward is also displayed. A Uniform Resource Locator link 405 to the redemption server is provided, enabling the user to easily access the reward web page via an Internet connection assuming a connection can be established.

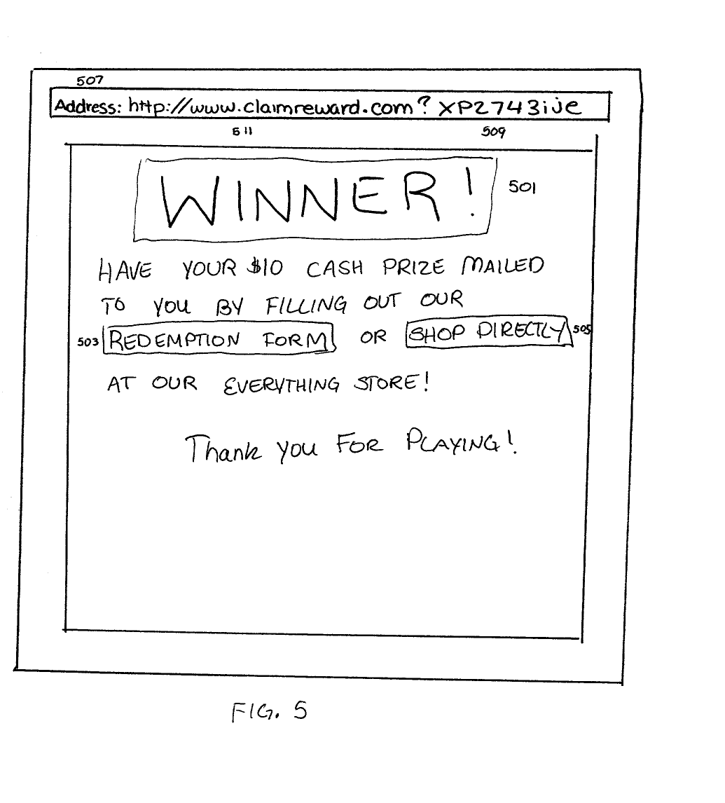

FIG. 5 illustrates a display page providing a set of reward redemption options in one embodiment. The redemption server generates the display page with these options while the user is visiting a redemption web site after successfully completing the computer game. In this embodiment, a text message 501 congratulating the user is displayed. In order to redeem the reward, the user may select (e.g., click on) a “redemption form” link 503 to have a cash reward mailed, or, alternatively, select a “shop directly” link 505 that enables the user to redeem the reward by purchasing items from an online store. The address bar 507 displays the Uniform Resource Locator 511 of the redemption web site. The game outcome code 509 (i.e., “XPZ7431JE”) is appended to the Uniform Resource Locator. The redemption server uses this game outcome code to verify that the user was successful at the computer game. The redemption server may check one of its databases to ensure that the code is valid and indicates success. If one of these conditions is not met, then the redemption server may provide a losers display page. Also, the redemption server may ensure that the reward for a game is only redeemed once.

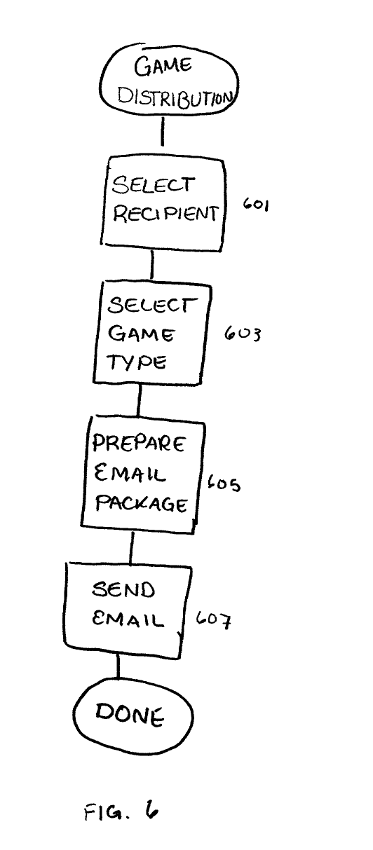

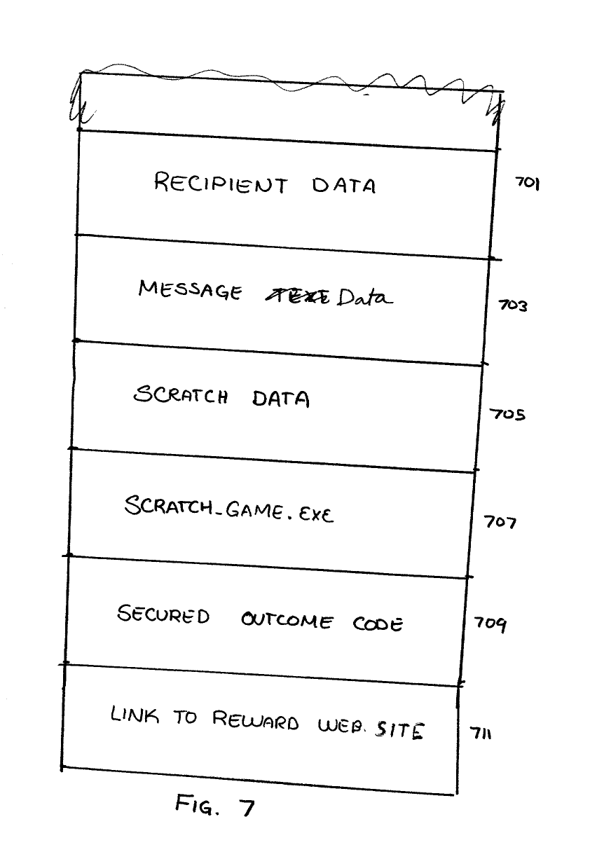

FIG. 6 is a flow diagram illustrating the processing of the game program distribution routine in one embodiment. This routine may be part of the game server and used to generate and send emails containing games. In block 601, the routine selects the game recipient from a user database. The user database may, for example, identify customers of a merchant web site who have not visited the web site for a certain period of time. The merchant may want to send the email with the game to stimulate interest in the web site. In block 603, the routine selects a game type to be embedded into an email message. If the outcome of the game is predetermined, the selected game may also include a game outcome code. In block 605, the routine prepares the email message illustrated in FIG. 7, which may include the game recipient's email address, an executable game file, game data, a game outcome code, and a link to the redemption web site. In block 607, the routine sends the email message to the game recipient.

FIG. 7 is a block diagram illustrating the components of an email message containing an electronic scratch game with a predetermined outcome in one embodiment. The email message includes game recipient data 701, message data 703, scratch data 705, an executable electronic scratch game program file 707, a secured game outcome code 709, and a link 711 to a redemption web site. The game recipient data may include the name and email address of the user. The message data may provide instructions for executing the electronic scratch game and may be viewed by the user immediately upon opening the received email message. The message data may also include various advertisements. In one embodiment, the electronic scratch game program accesses the scratch game data for a particular occurrence of the game. Although the executable scratch game program may be standardized, each individual email message may contain unique scratch game data and a corresponding game outcome code. One skilled in the art will appreciate that the scratch data and link may be embedded within the game program file. In addition, all of or certain portions of the email message maybe encrypted.

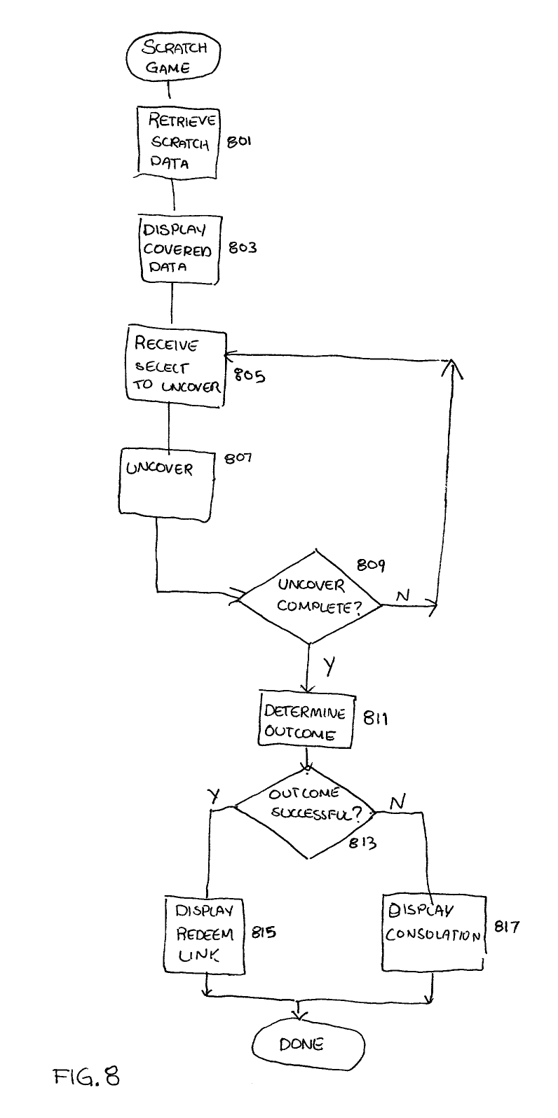

FIG. 8 is a flow diagram illustrating the processing of an electronic scratch game program in one embodiment. The electronic scratch game program allows the user to play the electronic scratch game and then displays the outcome. In block 801, the electronic scratch game program retrieves scratch data embedded in the email. In block 803, the electronic scratch game program displays covered scratch data to the user (e.g., five ellipses covering dollar amounts). In block 805, the electronic scratch game program receives a selection from the user to uncover some of covered scratch data (e.g., clicking on an ellipses). In block 807, the selected cover is removed revealing uncovered scratch data in human readable form (e.g., “$10”). In decision block 809, if all the scratch data has not yet been uncovered, the electronic scratch game program executes a loop in which it responds to the user's selections to uncover. Once all scratch data has been uncovered (or matching ellipses have been uncovered), the electronic scratch game program continues at block 811 where the electronic scratch game program determines the outcome. For example, the program may need to check the dollar amounts for a match. Alternatively, a winning or a losing program could be added to the email, depending on the predetermined outcome, that automatically performs a winning or losing behavior at the end of the game. In decision block 813, if the outcome of the game is successful, then the electronic scratch game program continues at block 815, else the electronic scratch game program continues at block 817. In block 815, the electronic scratch game program displays a link to a redemption web site. In block 817, the electronic scratch game program displays a consolation message. The program then completes.

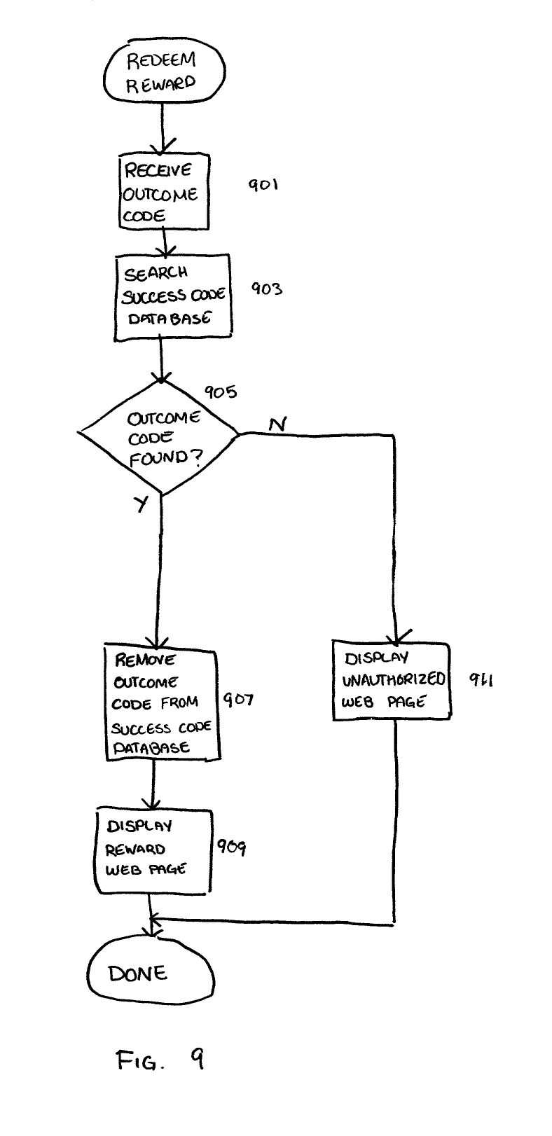

FIG. 9 is a flow diagram illustrating the processing of the redemption routine in one embodiment. The redemption routine receives and verifies a game outcome code submitted by the user and provides a successful user with redemption options. The redemption routine may execute at the redemption server. In block 901, the routine receives a game outcome code. In one embodiment, as illustrated in FIG. 4, the game outcome code may be automatically appended to a Uniform Resource Locator linking the user from the computer game program to the redemption server. In block 903, a search of the success code database is conducted. In decision block 905, if the game outcome code is found in the success code database, then the routine continues at block 907, else the routine displays a web page indicating that access to a reward is unauthorized in block 911. In block 907, the routine removes the received game outcome code from the success code database. This prevents the user from redeeming a reward more than one time. In block 909, the routine displays a reward web page in order to facilitate selection and delivery of the reward. One skilled in the art will appreciate that the outcome code may be encoded so that the outcome can be derived from the code itself without needing to access a success code database.

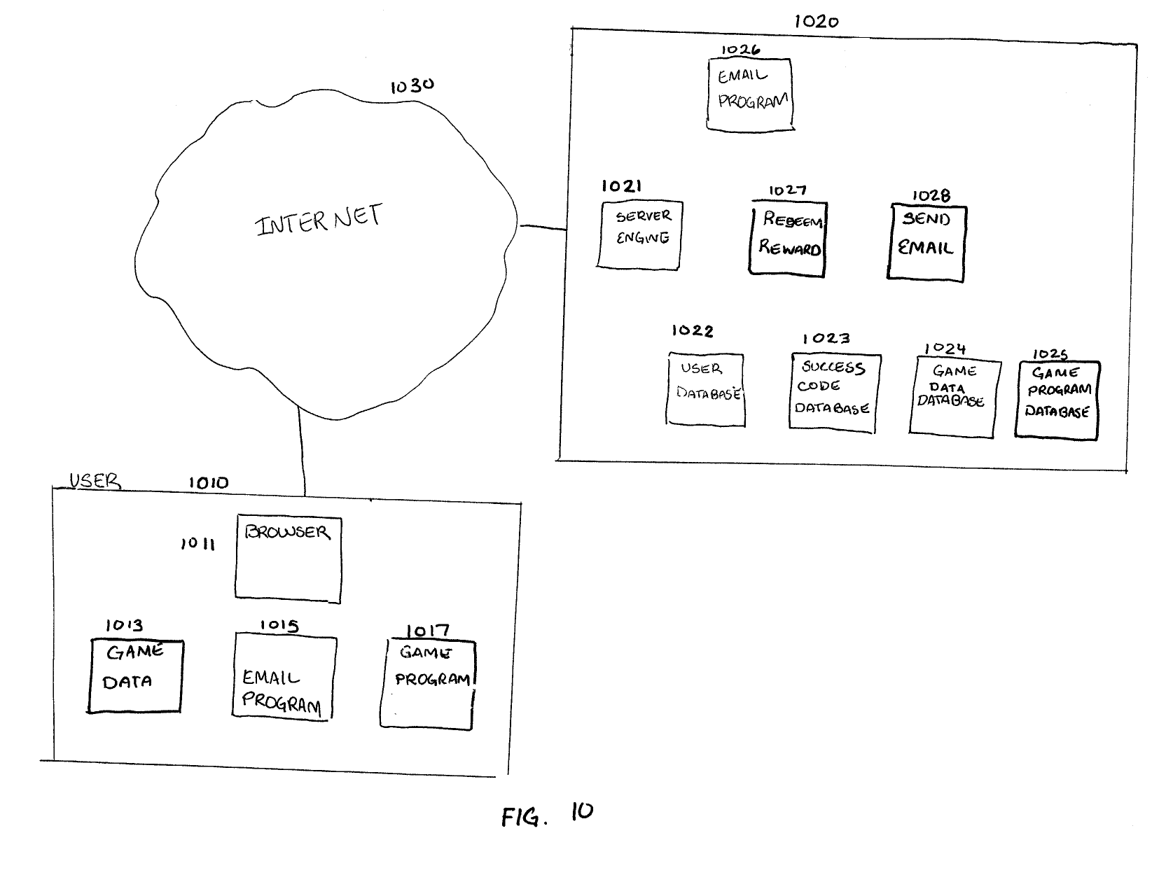

FIG. 10 is a block diagram illustrating components used to implement the computer game system in one embodiment. The user computer 1010 and the game/redemption computer 1020 are interconnected via the Internet 1030. In this embodiment, the game server and redemption server functionality are hosted on the same computer. One skilled in the art will appreciate that they could be hosted on separate computers. The computers may include a central processing unit, memory, input devices (e.g., keyboard and pointing devices), output devices, (e.g., display devices), and storage devices (e.g., disk drives). The memory and storage devices are computer-readable media that may contain instructions that implement the game playing and reward systems. In addition, the data structures and message structures may be stored or transmitted via a data transmission medium, such as a signal on a communications link. Various communications channels other than the Internet may be used, such as a local area network, a wide area network, or a point-to-point dial-up connection. User computer 1010 includes a browser 1011, an email program 1015 (e.g., Microsoft's Outlook), a game program 1017, and game data 1013. The game program and game data may be received via an electronic mail message. The game/redemption computer server 1020 includes a server engine 1021, a game program database 1025, a game data database 1024, a success code database 1023, a user database 1022, an email program 1026, a reward redemption component 1027, and a send email component 1028. One skilled in the art will appreciate that the various databases (or more generally data stores or files) can be combined into a single database or divided into multiple databases. The send email component generates and sends electronic mail messages with games. The game program database may contain programs for different types of games (e.g., scratch-off or slot games). The send email component may randomly select the type of game to include in an electronic mail message. Alternatively, it can send a user a different type of game in each electronic mail message or a user can specify a preference for the type of game. The game data database may contain a record of the game data sent in each electronic mail message. The send email component may generate game data dynamically based on a desired probability of winning. The success code database may contain an entry for each electronic mail message that has a winning outcome. The redeem reward component coordinates the redeeming of a reward.

From the foregoing it will be appreciated that, although specific embodiments of the technology have been described herein for purposes of illustration, various modifications may be made without deviating from the spirit and scope of the invention. For example, the computer game email message may provide more than one chance for the user to win and may contain a variety of computer games in a single email message. Also, the outcome of the computer game may be based on factors such as the user's skill or the speed in which the user completes the computer game. The means used to verify the outcome of the game might also vary. For example, success at a skill-based game may be verified by the use of a data file that contains information relating to the game program as executed. The computer game outputs information in ways other than display on a computer screen, such as in audio form. The technology can be used with personal computers, cell phones, personal digital assistants, and so on. Accordingly, the invention is not limited except by the appended claims.

I/we claim:

1. A method in a computer for playing a computer game, the method comprising:
receiving via a communications link an electronic mail message containing the computer game;
executing the received computer game so that a user can play the received computer game;
displaying an outcome once playing of the computer game is completed; and
when the displayed outcome indicates success, coordinating the redeeming of a reward from a redemption server via a communications link
wherein the computer game is played without interacting with another computer.

2. The method of claim 1 wherein the outcome of the computer game is predetermined.

3. The method of claim 2 wherein the computer game is played by uncovering items on a computer display, the items indicating the outcome of the computer game.

4. The method of claim 2 wherein the computer game is a scratch-game.

5. The method of claim 1 wherein the outcome is based on the performance of the user while playing the game.

6. The method of claim 1 wherein coordinating includes displaying a link for a redemption web site.

7. The method of claim 6 wherein the link includes an outcome code.

8. The method of claim 1 wherein the electronic mail message includes an outcome code.

9. The method of claim 1 wherein the computer game generates an outcome code.

10. The method of claim 1 wherein the computer game includes an executable game and game data.

11. The method of claim 1 wherein the computer game includes a component for automatically downloading an executable game if not already stored on the computer.

12. A method in a computer for supplying a computer game the method comprising:
preparing an electronic mail message containing the computer game, the computer game having executable instructions that allow a user to play the computer game, that display an outcome upon completion of the computer game, and that support redeeming a reward;
sending the prepared email to a client computer;
receiving an indication that the game was successful; and
providing a reward based on success at the computer game.

13. The method of claim 12 wherein the outcome of the computer game is predetermined.

14. The method of claim 12 wherein the computer game is a scratch-game.

15. The method of claim 12 wherein the outcome is based on the performance of the user while playing the game.

16. The method of claim 12 wherein the received indication includes a game outcome code.

17. The method of claim 16 including determining whether the game outcome code indicates success.

18. The method of claim 12 wherein the electronic mail message includes a game outcome code.

19. The method of claim 18 including identifying whether the game outcome code was previously redeemed.

20. A method in a computer for playing a computer game, the method comprising:
receiving via a communications link, an electronic mail message containing the computer game, the computer game having an outcome that is predetermined;
executing the received computer game so that a user can discover the predetermined outcome;
displaying the predetermined outcome once playing of the computer game is completed; and
when success is indicated, displaying a link for redeeming a reward from a redemption server.

21. The method in claim 20 wherein the link is a Uniform Resource Locator.

22. The method in claim 20 wherein the link includes an outcome code that is sent to the redemption server when the link is selected.

23. A method in a computer for playing a computer game, the method comprising:
receiving a game outcome discovery program;
receiving, via electronic mail, encoded game data indicating a predetermined outcome;
executing the game outcome discovery program to discover the predetermined outcome;
displaying the predetermined outcome once playing of the computer game is completed; and
when success is indicated, displaying information for redeeming a reward from a reward server system.

24. The method in claim 23 wherein the encoded game data consists of scratch game data.

25. A computer-readable medium containing instructions for controlling a computer system to play a computer game, by a method comprising:
receiving via a communications link an electronic mail message containing the computer game;
executing the received computer game so that a user can play the received computer game;
displaying an outcome once playing of the computer game is completed; and
when the displayed outcome indicates success, displaying information for redeeming a reward from a reward server system via a communications link.

26. A computer-readable medium containing instructions for controlling a computer system to supply a computer game, by a method comprising:
preparing an electronic mail message containing the computer game, the computer game having executable instructions that allow a user to play the computer game, display an outcome upon completion of the computer game, and support redeeming a reward;
sending the prepared email to a client computer;
receiving an indication that the game was successful; and
providing a reward based on success at the computer game.

27. A computer-readable medium containing instructions for controlling a computer system to play a computer game, by a method comprising:
receiving a game outcome discovery program;
receiving, via electronic mail, encoded game data indicating a predetermined outcome;
executing the game outcome discovery program to discover or decode the predetermined outcome;
displaying the predetermined outcome once playing of the computer game is completed; and
when success is indicated, displaying a link for redeeming a reward from a reward server system.

28. A computer system for playing a computer game, comprising:
means for receiving via a communications link an electronic mail message containing the computer game;
means for executing the received computer game so that a user can play the received computer game;
means for displaying an outcome once playing of the computer game is completed; and
means for redeeming a reward from a reward server system via a communications link.

29. A computer system for supplying a computer game, comprising:
means for preparing an electronic mail message containing the computer game, the computer game having executable instructions that allow a user to play the computer game, that display an outcome upon completion of the computer game, and that support redeeming a reward;
means for sending the prepared email to a client computer;
means for receiving an indication that the game was successful; and
means for providing a reward based on success at the computer game.

30. A computer system for playing a computer game, comprising:
means for receiving a game outcome discovery program;
means for receiving, via electronic mail, encoded game data indicating a predetermined outcome;
means for executing the game outcome discovery program to discover or decode the predetermined outcome;
means for displaying the predetermined outcome once playing of the computer game is completed; and
means for when success is indicated, displaying a link for redeeming a reward from a reward server system.
